(19) United States
(12) Patent Application Publication
(10) Pub. No.: US 2023/0316184 A1
(43) Pub. Date: Oct. 5, 2023

(54) AUTOMATED COMPLIANCE BENCHMARK MANAGEMENT

(71) Applicant: International Business Machines Corporation, Armonk, NY (US)

(72) Inventors: Anthony Erwin, Round Rock, TX (US); Nataraj Nagaratnam, Cary, NC (US)

(21) Appl. No.: 17/657,179

(22) Filed: Mar. 30, 2022

(51) Int. Cl. G06Q 10/06

(52) U.S. Cl. CPC G06Q 10/06315; G06Q 10/06393

(57) ABSTRACT

A request to generate an automated compliance verification framework for an organization is received. A neural network analyzes industry and internal regulations of the organization, as well as existing record-keeping and data processing applications of the organization. The neural network determines a set of benchmarks derived from existing variables from the record-keeping and data processing applications to objectively verify compliance or non-compliance with the industry and internal regulations. The neural network determines these benchmarks by comparing data of the record-keeping and data processing applications against the industry and internal regulations. A compliance system is caused to execute an automated test of each of the set of benchmarks verifying whether the organization is objectively in compliance with the industry and internal regulations.

### BACKGROUND

As more and more day-to-day activity and record keeping is done (and stored) on various software applications, there is an increasing need to verify that this activity and record keeping is done in a safe and compliant way. This may include complying with various industry regulations, industry best practices, internal security standards, internal preferences, or the like. Further, given that in a modern environment these best practices are often being updated independently of software applications being replaced or other modified, it can be difficult for organizations to keep an accurate count of what the current regulations are, and what being compliant against those regulations looks like given their current set of hardware and software products.

### SUMMARY

Aspects of the present disclosure relate to a method, system, and computer program product relating to an automated compliance verification framework that dynamically is updated to capture applicable regulations for an organization as can be objectively measured by tools used by the organization. For example, the method includes receiving a request to generate an automated compliance verification framework for an organization. The method also includes analyzing, by a neural network, industry regulations and internal regulations of the organization. The method also includes analyzing, by the neural network, existing record-keeping and data processing applications of the organization. The method also includes determining, by the neural network comparing data of the record-keeping and data processing applications against the industry and internal regulations, a set of benchmarks derived from existing variables from the record-keeping and data processing applications to objectively verify compliance or non-compliance with the industry and internal regulations. The method also includes verifying whether the organization is objectively in compliance with the industry and internal regulations by causing a compliance system to execute an automated test of each of the set of benchmarks. A system and computer program configured to execute the method described above are also described herein.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a conceptual diagram of an example system in which controller may dynamically and autonomously manage a compliance verification framework for an organization.

FIG. 2 depicts a conceptual box diagram of example components of the controller of FIG. 1.

FIG. 3 depicts an example flowchart by which the controller of FIG. 1 may manage the compliance verification framework.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to managing compliance standards for an organization, while more particular aspects of the present disclosure relate to dynamically and autonomously identifying and pairing regulations for an organization with benchmarks that can verify objective compliance with said regulations, and therein updating these across time and various organizations based on learned observations. While the present disclosure is not necessarily limited to such applications, various aspects of the disclosure may be appreciated through a discussion of various examples using this context.

Many organizations are concerned with being compliant with various regulations and standards, such as financial regulations, healthcare regulations, or other types of governmental regulations. For example, regulations as used herein may include industry regulations and standards such as National Institute of Standards and Technology (NIST) standards (such as NIST 800-53), payment card industry data security standards (PCI DSS), health insurance portability and accountability act (HIPAA) regulations, or the like. Beyond this, regulations as used herein may also include high-level policies, controls, and requirements, such as best practices to ensure that an organization has compliant workloads using sufficient underlying technologies, or the like. For example, some industries may require a system security plan (SSP) that defines the security requirements for an organizations information technology (IT) infrastructure, where the regulations include both requirements as to how to create an approved infrastructure as well as how to demonstrate realization of such an approved infrastructure.

Manually verifying that the regulations have been satisfied (and then creating evidence thereof) can be a time consuming and error-prone process for both a relevant conventional software provider and a corresponding human auditing team. For example, conventional systems may be configured to run tests to verify that various hardware and software assets are compliant, including mapping a set of static regulations to a set of known and static factors/fields/variables of the hardware and software assets (e.g., such that conventional compliance system can check these factors/fields/variables to test compliance). However, given the robust nature of things that an organization is looking to confirm compliance with, in reality conventional systems require one or more skilled regulatory experts to work hand-in-hand with information technology (IT) professionals and software programmers to map each regulation to a field within a supporting software application that can capture compliance or lack thereof. This may include IT professionals looking to existing record-keeping applications (e.g., back-end systems that store future, current, or historical data) as well as data processing applications (e.g., software applications that receive data from customers and vendors and the like and process this received data as part of a product provided by the organization) to identify fields that currently exist that could verify compliance. Beyond this, such a process as executed by conventional systems requires numerous humans understanding every way that noncompliance could happen, and accurately having another human determining whether this instance of noncompliance is occurring in a manner capturable by the conventional systems.

Further, regulations, record-keeping applications, and data processing applications often undergo revisions (if not whole-sale replacements) over time. This means that for conventional systems, this manual process is inherently an ongoing one. Being as conventional systems are manually set up and statically linked to regulations, these conventional systems lack a technical ability to detect (much less act upon) such revisions/replacements. When adding to the further failure of conventional systems to assist in the generation of the compliance tests itself, a significant burden is placed upon humans that are trying to confirm ongoing compliance.

Aspects of this disclosure improve or address technical shortcomings of conventional systems to better manage the ongoing compliance of organizations. For example, aspects of this disclosure relate to dynamically and autonomously identifying and pairing regulations for organizations with current or potential data points such as configurations of software applications of these organizations, where these data points can serve as benchmarks that can objectively verify compliance with said regulations, where aspects of the disclosure may further update these benchmarks across time and various organizations based on learned observations. One or more computing devices that include one or more processing units executing instructions stored on one or more memories may provide the functionality that addresses these problems, where said computing device(s) are herein referred to as a controller. As discussed herein, regulations may include such things as risk and compliance-centric security (controls), organizational requirements, temporary or ongoing identified organizational threats, industry-centric guidance (e.g., prescriptive objectives or benchmarks), technology centric implementation requirements of the solution target system (e.g., where a specific vendor requires and/or suggests certain practices or configurations).

The controller may identify these benchmarks in a manner such that they can objectively measure whether or not the regulation has been complied with or not. The controller may interface (or otherwise include) a system that executes automated and autonomous tests to verify compliance. Further, the controller may use machine learning (ML) techniques as described herein to learn and improve at the act of identifying benchmarks for compliance. This may include the controller utilizing a neural network that undergoes supervised or unsupervised learning as the controller (or other instances of the controller) are deployed to increasing organizations across numerous industries with different software applications and preferences and the like.

For example, the controller can be deployed to an organization. Once deployed, the controller may be feed (or otherwise given access to) regulations of the organization. The controller may identify an industry of the organization, tools used by the organization, products provided by the organization, or the like, and may further identify additional regulations that come from one or more of these sources (e.g., both industry and internal regulations). These regulations may be uniquely tailored to the industry, platforms, and products of the organization. From here, the controller may be fed (or otherwise given access to) hardware and software of the organization, such as record-keeping software applications and data processing software applications. The controller may analyze these applications using a neural network or the like to identify a set of benchmarks derived from existing variables of the applications of the organizations, where the variables are data points or data fields from the applications, and the benchmarks are able to objectively verify compliance or non-compliance with the regulations. The controller may realize these benchmarks as deployment scripts that could be used to automate tests to verify compliance of each regulation, doing so on a predetermined schedule.

The controller may be further configured to crawl across applications, products, industries databases of the organization, and the like to verify that nothing has changed that would invalidate the validity of the automated compliance tests. For example, the controller may crawl over some or all of these locations to verify that nothing has changed regarding regulations governing the organization, such that the benchmarks should be updated. For another example, the controller may crawl over the internal applications of the organization to determine whether anything has been modified such that the benchmarks are no longer able to objectively verify compliance. In some examples, this may include the controller detecting that the applications changed such that there is a more robust way of verifying compliance (e.g., where this more robust manner of verifying compliance would be able to verify future compliance in addition to current compliance, whereas the previous manner of verifying compliance prior to the application change was only able to verify current compliance and/or past compliance). Where the controller is able to detect that something has changed in one of these manners, the controller will update the benchmarks to verify compliance in the new manner as detected by the controller.

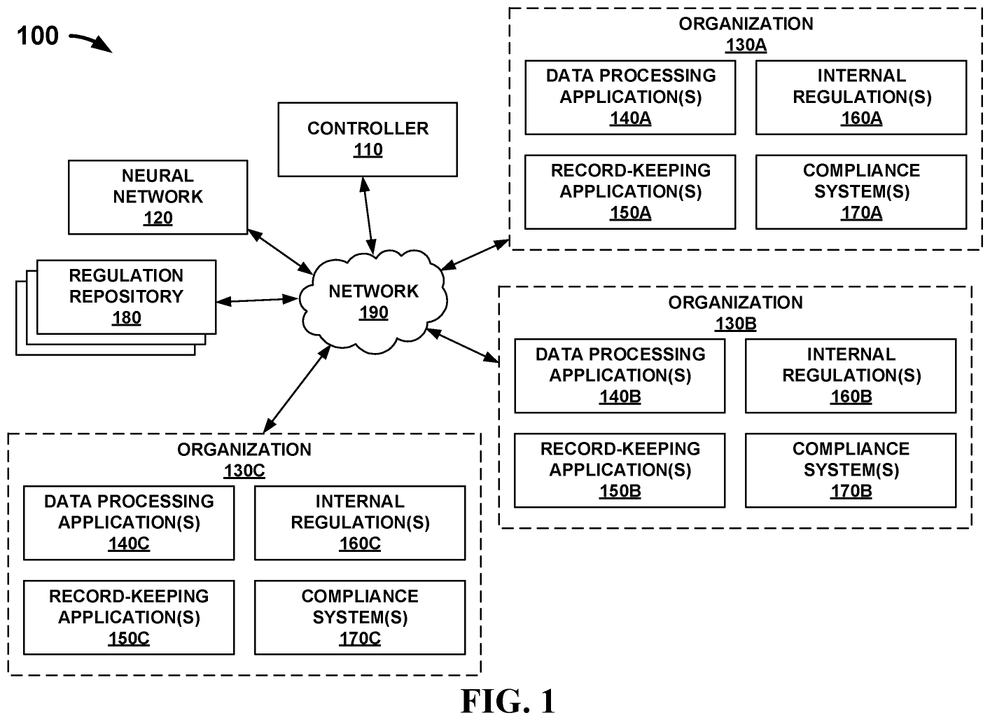

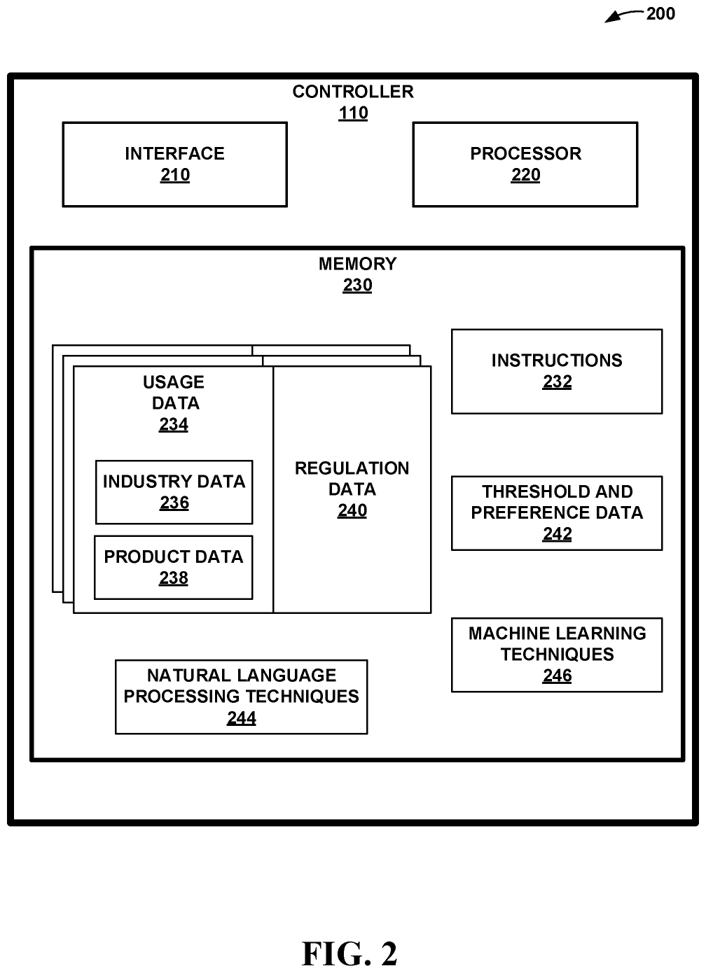

For example, FIG. 1 depicts environment 100 in which controller 110 uses neural network 120 to manage compliance of organizations 130A-130B (collectively referred to herein as “organizations 130”) as discussed herein. Controller 110 may include a processor coupled to a memory (as depicted in FIG. 2) that stores instructions that cause controller 110 to execute the operations discussed herein. Though controller 110 is depicted as being structurally distinct from neural network 120 and all components of organizations 130, in some embodiments controller 110 may be integrated into neural network 120, and/or an instance of controller 110 (and perhaps an instance of neural network 120) may be integrated into a component of organizations such as one of compliance systems 170A-170C (collectively, “compliance systems 170”). Organizations 130 may include businesses, government entities, non-profits, or any other entity that is looking to verify that a structure and/or utilization of computing hardware and software is aligned with known preferences that are discussed herein as “regulations” (where these preferences/regulations can include governmental regulations, industry certifications, internal best practices, or the like).

Controller 110 may verify compliance for organizations 130 via a set of benchmarks derived from existing variables from one or more data processing applications 140A-140C (collectively referred to herein as “data processing applications 140”) and/or one or more record-keeping applications 150A-150C (collectively referred to herein as “record-keeping applications 150”) of organizations 130. As used herein, data processing applications 140 includes computing hardware and software that is used to receive, transform, and/or generate data. Data processing applications 140 may include customer facing products, back-end systems, or the like. Conversely, record-keeping applications 150 includes computing hardware and software that is used to store data, whether on a short term or long term basis. Though each of organizations 130 is depicted as being a discrete entity of a similar size with similar components in FIG. 1 for purposes of illustration, in some examples there may be overlap between some organizations 130, and organizations 130 may differ significantly or minimally in scope and configuration. For example, organization 130A may be a subsidiary of organization 130B, while organizations 130B, 130C may share numerous record-keeping applications 150, etc.

Controller 110 may use a neural network 120 to manage compliance of organizations 130 regarding various regulations. These regulations include a preferred practice that involves computing hardware or software. The regulations (which in other instances are referred to within the industry as “controls”) may relate to a manner as to how data is to be stored, who is given access to data (and how that access is granted, such as potentially through users), an expected/preferred/required amount of encryption, a requirement of deleting data after a period of time, logging requirements of that data (including logging when data is accessed, changed, or shared), or the like. In many examples these regulations include “bright lines” rules, such that compliance or non-compliance according to these regulations may be objectively verified in real-time (and/or after-the-fact) by organizations 130 and/or regulatory bodies governing organizations 130.

Controller 110 may be fed or otherwise be given access to regulations via one or more repositories of internal regulations 160A-160C (collectively referred to herein as “internal regulations 160”) of respective organizations. Internal regulations 160 may include documents, webpages, or the like that detail company policies or best practices, and may be stored on, e.g., a webserver of respective organizations 130. Internal regulations 160 may be practices relating to computing hardware or software that are intended primarily or exclusively for a respective organization 130 (e.g., such that they are created with one single organization 130 in mind, rather than being created for, e.g., a full industry). In some examples, internal regulations 160 are unique to a respective organization 130. Alternatively, or additionally, controller 110 may be fed or otherwise given access to regulations from regulation repository 180. Regulation repository 180 may include regulations that are provided by an entity that is external to organizations 130, such as a governing body or a technical body that releases regulations or best practices or the like. Regulations of regulation repository 180 may relate to a plurality of organizations 130.

Once controller 110 generates benchmarks that objectively verify compliance or noncompliance of regulations for a respective organization 130, controller 110 may cause one of compliance systems 170A-170C (collectively referred to herein as “compliance systems 170”) to execute an automated test using these benchmarks (e.g., where an automated test means a test that is not caused and/or supervised by a human). As depicted, in some examples each organization 130 may include a respective compliance system 170, though in other examples compliance system 170 may be integrated into controller 110 (or vice versa) such that controller 110 itself executes an automated test. This automated test as executed by controller 110 may objectively verify compliance or non-compliance of each regulation. Controller 110 may cause these automated tests to run in response to a trigger, where this trigger may be a timer that expires at predetermined intervals and/or one or more events that warrant a compliance check.

Once controller 110 causes an automated test to run, controller 110 may send a report to a respective organization 130, where this report may provide metrics on compliance or noncompliance of the regulations. For example, controller 110 may send such a report to organizations 130 over network 190. Network 190 may include a computing network over which computing messages may be sent and/or received. For example, network 190 may include the Internet, a local area network (LAN), a wide area network (WAN), a wireless network such as a wireless LAN (WLAN), or the like. Network 190 may comprise copper transmission cables, optical transmission fibers, wireless transmission, routers, firewalls, switches, gateway computers and/or edge servers. A network adapter card or network interface in each computing/processing device (e.g., computing devices that host/include controller 110, neural network 120, data processing applications 140, recording-keeping applications 150, internal regulations 160, compliance systems 170, and/or regulation repository 180) may receive messages and/or instructions from and/or through network 190 and forward the messages and/or instructions for storage or execution or the like to a respective memory or processor of the respective computing/processing device. Though network 190 is depicted as a single entity in FIG. 1 for purposes of illustration, in other examples network 190 may include a plurality of private and/or public networks.

In this way, the controller 110 may use the neural network 120 to provide an intelligent, context-aware guided experience to respective organizations 130, allowing each organization 130 to construct a tailor-made list of implementation goals that are in a format that can be used in a variety of ways (documentation, deployment and configuration, on-going automated tests, etc.). Further, as detailed herein, being as this list of implementation goals (e.g., the regulations as discussed herein) are created by neural network 130 based on a learned knowledge base of industry informed regulations and technology specific mapping, organizations 130 may have little or no need to have a compliance expert in order to be compliant.

For example, controller 110 may interface with organization 130A in the form of a guided experience (or wizard) to help normalize regulations such as industry specific regulations, technical best practices, customer demands, and the like into concrete benchmarks by mapping these into goals for workloads as running on the data processing applications 140A of organization 130A. Controller 110 may start this by identifying elements of organization 130A that impact regulations, such as an industry (e.g., banking, insurance, healthcare) of organization 130A, products of organization 130A, legal requirements or controls associated with organization 130A, a geography of organization 130A (including a geography in which organization 130A is headquartered and has business operations), a sensitivity of data handled by organization 130A, or the like. Controller 110 may further account for various regulations coming from architecture used by respective organizations 130, such as a platform (e.g., a cloud computing platform, a software-as-a-service platform, or the like) used by organizations 130 that define safe usages of their platforms.

This wizard may also be used by controller 110 in identifying regulations from regulation repository 180, where this includes regulations related to risk and compliance-centric security (controls), industry-centric guidance (prescriptive objectives), technology-centric implementation requirements of the data processing applications 140A and/or record-keeping applications 150A (e.g., a cloud computing provider used by organization 130A). Controller 110 may further identify organizational requirements and specific organizational threats specific to organization 130A as stored within internal regulations 160A, such as promises or assertions that organization 130A makes to their customers.

Controller 110 may use neural network 120 to identify regulations. For example, controller 110 may feed the information provided above into neural network 120, and neural network 120 may predict regulations that govern organization from these inputs via processing all of this contextual information. For example, controller 110 may identify that organization 130A is looking to use a cloud computing platform ABC to provide a financial services solution within the healthcare industry that accepts credit cards, and may feed all of this information into neural network 120. Neural network 120 may then output that this would make organization 130A behold to regulations that relate to financial and healthcare matters, such as PCI DSS, HIPAA, and any associated regulations from the cloud computing platform ABC.

Controller 110 may then gather information on each of these regulations, such as a regulation description, a regulation objective, and any implementation, evidence, or guidance offered by respective entities (e.g., a group that puts out the regulation, a provider of a tool used by organization 130A that needs to abide by the regulation, etc.). Controller 110 may feed this information into neural network 120, along with data on infrastructure of organization 130. Using this data, neural network 120 outputs a compliance framework with benchmarks to objectively verify compliance, where this framework factors for the contextual information of organization 130A such that the benchmarks are based on the standards involved.

For example, controller 110 may feed neural network 120 data-sensitivity-based policies and regulations, such as a first internal regulation that data is to be encrypted and a second industry regulation that mandates that a financial group must control the security keys. Neural network 120 may synthesize these two regulations and output an overriding regulation of keep your own key (KYOK), where controller 110 could functionally govern this regulation with a goal such as “Ensure data is encrypted at rest with KYOK.” Conversely, if controller 110 feeds neural network 120 another regulation that states that the data classification should be “secret,” controller 110 may instead identify a goal of “Ensure data classified as ‘secret-data’ should be protected by ‘KYOK onprem’.”

For another example, controller 110 may feed neural network 120 risk-based regulations. This may include controller 110 feeding neural network 120 information on organization 130B that is located in the European Union (EU), where organization 130A is confronted with a risk that arises from hosting data outside of the EU (e.g., such as data hosted in the United States). Neural network 120 may synthesize this as a need to encrypt any data hosted outside of the EU with KYOK, where controller 110 provides this as a goal of “Ensure data hosted in the U.S. is encrypted with KYOK.”

For another example, controller 110 may feed neural network 120 technology-specific regulations. This might include a situation where controller 110 detects that organization 130A is using a cloud that requires that organization use a specific technology product. For example, controller 110 may detect a pledge that organization 130A made to its customers to always use a key management service and hardware security module (HSM) that is built on FIPS 140-2 level 4-certified hardware (e.g., like IBM® Cloud Hyper Protect Crypto Services HPCS®). In this situation, controller 110 may generate a goal of “ensure data encrypted with KYOK uses an HSM meting these standards.”

Controller 110 may determine benchmarks using neural network 120 to allow a fine tuning of goals and associated benchmarks. For example, controller 110 may determine that organization 130A has internal requirements for passwords that are more restrictive than a baseline as established by the industry or by a platform used by organization 130A. As such, controller 110 may identify that the more rigorous/restrictive requirement is the one that “wins,” and may create benchmarks accordingly.

Controller 110 may receive input from organizations 130A, where this input/feedback is fed back into neural network 120 to help neural network 120 learn. For example, controller 110 may receive one or more requirements that controller 110 and/or neural network 120 did not identify. These regulations may be sent in by an expert within organization 130A that identified these regulations as missing within the benchmark framework generated by controller 110. In some examples, in addition to receiving the regulations themselves, controller 110 may further receive an indication as to where these regulations originated (e.g., a document or webpage that details these regulations, and/or details how and why they relate to organization 130A), such that this may be used to train neural network 120 in getting better at generating the compliance framework over time. Such regulations may include regulations that were previously used but not carried over, and/or new custom goals that organizations 130 find helpful. In some examples, controller 110 may merely receive these goals/regulations from organizations 130 in a natural language format (“we need to verify that data stored in database ABC is encrypted with XYZ”), whereas in other examples controller 110 may enable organizations 130 to write a script for an automated benchmark by, e.g., having a member of a respective organization select piece parts to (for example) verify the setting of a certain configuration value that is not covered in existing goal regulations.

Controller 110 generates benchmarks such that they are context-aware of the environment of respective organizations, such that generated and/or updated benchmarks evolve over time based on risk and threat. For example, controller 110 may identify that attacks and/or threats are originated from certain geographic regions, such that network regulations should include treating traffic incoming from internet protocol (IP) addresses associated with those geographic regions differently. Controller 110 may feed this information into neural network 120, and may eventually identify an implicit regulation of blocking traffic from such IP addresses, even if there is no regulation that specifically details such a requirement within internal regulations 160 and/or regulation repository 180. Additionally, or alternatively, controller 110 may raise such an identified trend to an administrator within the respective organization 130, in response to which a new benchmark is generated. Similarly, controller 110 may determine if attacks are from (or are targeted against) a certain part of a network, or a certain product, or the like, and may inform organizations 130 and/or update benchmarks accordingly. In these ways, controller 110 may enable significant customization on any number of factors as dynamically presented by threats or as requested by organizations 130.

Controller 110 may be configured to generate a full list of all of the regulations with associated metadata. For example, this metadata could include the deployment script, the underlying regulation documentation, or the like. Controller 110 may be configured to generate such full lists that include all information required to create compliance frameworks in order to homogenize efforts across organizations 130. Specifically, this full list of all of the compliance framework data, once finalized, may be fed into neural network 120 so that neural network 120 may learn associations within this full list as it relates to characteristics of organizations 130 and the like. This may improve an ability of controller 110 to dynamically generate benchmarks in the future.

As described above, controller 110 may include or be part of a computing device that includes a processor configured to execute instructions stored on a memory to execute the techniques described herein. For example, FIG. 2 is a conceptual box diagram of such computing system 200 of controller 110. While controller 110 is depicted as a single entity (e.g., within a single housing) for the purposes of illustration, in other examples, controller 110 may include two or more discrete physical systems (e.g., within two or more discrete housings). Controller 110 may include interface 210, processor 220, and memory 230. Controller 110 may include any number or amount of interface(s) 210, processor(s) 220, and/or memory(s) 230.

Controller 110 may include components that enable controller 110 to communicate with (e.g., send data to and receive and utilize data transmitted by) devices that are external to controller 110. For example, controller 110 may include interface 210 that is configured to enable controller 110 and components within controller 110 (e.g., such as processor 220) to communicate with entities external to controller 110. Specifically, interface 210 may be configured to enable components of controller 110 to communicate with neural network 120, devices of organizations 130, regulation repositories 180, or the like. Interface 210 may include one or more network interface cards, such as Ethernet cards and/or any other types of interface devices that can send and receive information. Any suitable number of interfaces may be used to perform the described functions according to particular needs.

As discussed herein, controller 110 may be configured to dynamically generate compliance frameworks. Controller 110 may utilize processor 220 to manage regulation compliance in this way. Processor 220 may include, for example, microprocessors, digital signal processors (DSPs), application specific integrated circuits (ASICs), field-programmable gate arrays (FPGAs), and/or equivalent discrete or integrated logic circuits. Two or more of processor 220 may be configured to work together to monitor and manage regulation compliance accordingly.

Processor 220 may manage regulation compliance according to instructions 232 stored on memory 230 of controller 110. Memory 230 may include a computer-readable storage medium or computer-readable storage device. In some examples, memory 230 may include one or more of a short-term memory or a long-term memory. Memory 230 may include, for example, random access memories (RAM), dynamic random-access memories (DRAM), static random-access memories (SRAM), magnetic hard discs, optical discs, floppy discs, flash memories, forms of electrically programmable memories (EPROM), electrically erasable and programmable memories (EEPROM), or the like. In some examples, processor 220 may manage regulation compliance as described herein according to instructions 232 of one or more applications (e.g., software applications) stored in memory 230 of controller 110.

In addition to instructions 232, in some examples gathered or predetermined data or techniques or the like as used by processor 220 to manage data exhaust logging as described herein may be stored within memory 230. For example, memory 230 may include information described above that is gathered from environment 100. Specifically, as depicted in FIG. 2, memory 230 may include data usage data 234, which itself includes industry data 236 and product data 238, and memory 230 may also include regulation data 240. Usage data 234 may include data that creates a regulation, such as work in an industry (as stored within industry data 236) or a usage of various products (as stored within product data 238). Controller 110 may associate such data with the eventual regulations as stored within regulation data 240. By storing and updating this data, and updating it with datapoints from across industries and organizations and products, controller 110 may learn how to improve at providing compliance frameworks over time.

Further, memory 230 may include threshold and preference data 242. Threshold and preference data 242 may include thresholds that define a manner in which controller 110 is to manage compliance verification. For example, threshold and preference data 242 may include thresholds at which controller 110 is to alert an organization of something, update a benchmark, or the like, where, e.g., instances of a compliance issue of a first severity are responded to with a message to an administrator, instances of a relatively greater severity are responded to with a suggestion to change a benchmark to verify compliance, instances of a relatively greater severity still are responded to with autonomously changing a current network setting to block some traffic (e.g., in response to detecting that a regulation that verifies authenticity of traffic from this part of the network is failed), etc.

Memory 230 may further include natural language processing (NLP) techniques 244. NLP techniques 244 can include, but are not limited to, semantic similarity, syntactic analysis, and ontological matching. For example, in some embodiments, processor 220 may be configured to analyze natural language data of regulation documentation or the like as gathered from internal regulations 160, regulation repository 180, and/or other devices or components of network 190 to determine semantic features (e.g., word meanings, repeated words, keywords, etc.) and/or syntactic features (e.g., word structure, location of semantic features in headings, title, etc.) of this natural language data. Ontological matching could be used to map semantic and/or syntactic features to a particular concept. The concept can then be used to analyze an implicit regulation by tracking how this language is used across organizations 130, industries, or the like, so that relevant regulations may be identified and compliance thereof can be measured as described herein.

Memory 230 may further include machine learning techniques 246 that controller 110 may use to improve a process of managing regulation compliance as described herein over time. Machine learning techniques 246 can comprise algorithms or models that are generated by performing supervised, unsupervised, or semi-supervised training on a dataset, and subsequently applying the generated algorithm or model to manage regulation compliance. Using these machine learning techniques 246, controller 110 may improve an ability of determining whether all regulations are being identified and compliance thereof is accurately being measured. For example, controller 110 may identify over time certain types of regulations that usually exist in some industries and/or with some products, and may further learn what types of benchmarks accurately measure compliance with these regulations, becoming better at this over time as more and more data regarding it is gathered and analyzed.

Machine learning techniques 246 can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques. Specifically, machine learning techniques 246 can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning algorithms.

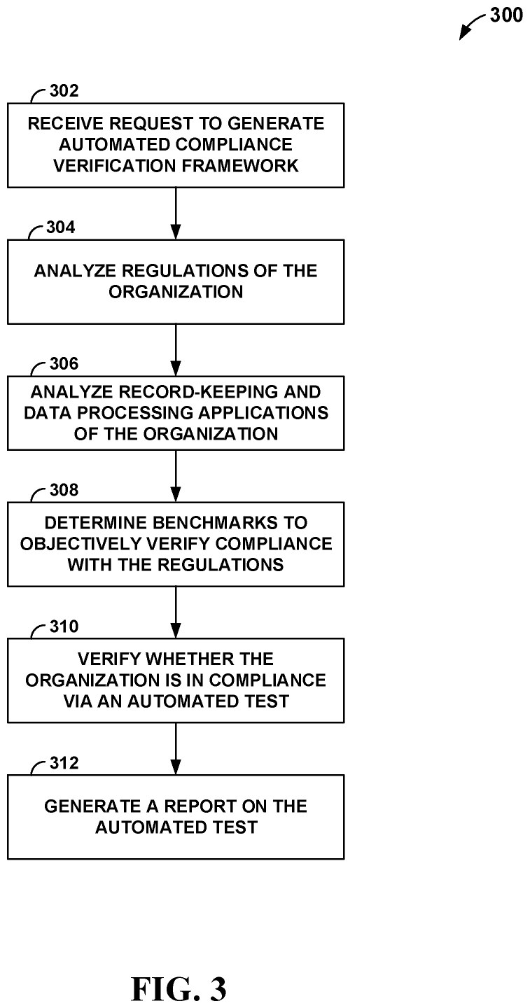

Using these components, controller 110 may manage regulation compliance as discussed herein. For example, controller 110 may manage regulation compliance according to flowchart 300 depicted in FIG. 3. Flowchart 300 of FIG. 3 is discussed with relation to FIG. 1 for purposes of illustration, though it is to be understood that other environments with other components may be used to execute flowchart 300 of FIG. 3 in other examples. Further, in some examples controller 110 may execute a different method than flowchart 300 of FIG. 3, or controller 110 may execute a similar method with more or less steps in a different order, or the like.

Controller 110 receives a request to generate an automated compliance verification framework (302). Controller 110 may receive this request from one or more organizations 130. In response to this request, controller 110 may analyze regulations of the respective organization 130 (304). This includes gathering data from internal regulations 160 and/or regulation repository 180 that matches the respective organization 130. Controller 110 may analyze this data by feeding it into neural network 120.

Controller 110 analyzes platforms and infrastructure of the organizations 130. Specifically, controller 110 analyzes record-keeping applications 150 and data processing applications 140 of organizations 130 (306). Controller 110 may analyze these by identifying aspects of these applications that relate to the regulations. Controller 110 may analyze these applications by feeding data of them into neural network 120.

Controller 110 determines benchmarks that objectively verify compliance with these regulations (308). Controller 110 may realize these benchmarks as deployment scripts that can execute operations on record keeping applications 150 and/or data processing applications 140 to verify objective compliance. Controller 110 may use neural network 120 to determine these benchmarks. Controller 110 verifies whether or not organizations 130 are in compliance with their regulations via an automated test (310). Controller 110 may generate the deployment scripts to cause this automated test. Controller 110 generates a report on this automated test (312). Controller 110 may send this report to organizations 130 of this report. This report may detail whether organizations 130 are compliant, what indicated said compliance (or lack thereof), and perhaps suggest additional regulations to verify compliance with.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-situation data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
receiving a request to generate an automated compliance verification framework for an organization;
analyzing, by a neural network, regulations of the organization;
analyzing, by the neural network, existing record-keeping and data processing applications of the organization;
determining, by the neural network comparing data of the record-keeping and data processing applications against the regulations, a set of benchmarks derived from existing variables from the record-keeping and data processing applications to objectively verify compliance or non-compliance with the regulations; and
verifying whether the organization is objectively in compliance with the regulations by causing a compliance system to execute an automated test of each of the set of benchmarks.

2. The computer-implemented method of claim 1, the method further comprising:
setting a time to expire at predetermined intervals after determining the set of benchmarks;
identifying that timer has expired after the predetermined interval; and
evaluating, by the neural network and in response to the instance of the periodic interval expiring, whether any of the regulations or record-keeping and data processing applications have changed such that it is no longer possible to verify that the organization is objectively in compliance with the regulations by causing the compliance system to execute the automated test of each of the set of benchmarks.

3. The computer-implemented method of claim 2, the method further comprising:
determining, by the neural network and in response to evaluating that the regulations have changed such that it is no longer possible to verify that the organization is objectively in compliance with the changed regulations, an updated set of benchmarks derived from the existing variables from the record-keeping and data processing applications to objectively verify compliance or non-compliance with the changed regulations; and
verifying whether the organization is objectively in compliance with the changed regulations by causing a compliance system to execute a new version of the automated test of each of the updated set of benchmarks.

4. The computer-implemented method of claim 2, the method further comprising:
determining, by the neural network and in response to evaluating that the record-keeping and data processing applications have changed such that it is no longer possible to verify that the organization is objectively in compliance with the regulations, an updated set of benchmarks derived from new existing variables from the record-keeping and data processing applications to objectively verify compliance or non-compliance with the regulations; and
verifying whether the organization is objectively in compliance with the regulations by causing a compliance system to execute a new version of the automated test of each of the updated set of benchmarks.

5. The computer-implemented method of claim 1, the method further comprising:
identifying, by the neural network comparing data of the existing record-keeping and data processing applications against the regulations, one regulation of the regulations that is incapable of being objectively measured for compliance or non-compliance with the existing record-keeping and data processing applications; and
suggesting, by the neural network, an alternative configuration of the existing record-keeping and data processing applications that would enable the one regulation to be objectively measured for compliance or non-compliance.

6. The computer-implemented method of claim 1, further comprising generating a report regarding the results of the automated test, wherein the report includes specific data from each benchmark that enabled the compliance system to determine whether the organization is in compliance with each industry and internal regulation.

7. The computer-implemented method of claim 1, further comprising training the neural network by feeding the neural network performance metrics of the automated compliance verification framework.

8. The computer-implemented method of claim 1, wherein the regulations are selected from a group that includes:
National Institute of Standards and Technology (NIST) standards;
payment card industry data security standards;
health insurance portability and accountability act (HIPAA) regulations;
high-level controls;
best practices of an industry of the organization; and
regulations on creating an approved infrastructure for a system security plan (SSP).

9. The computer-implemented method of claim 1, wherein benchmarks are realized as deployment scripts that can execute operations on the record keeping applications and the data processing applications to verify objective compliance with the regulations.

10. A system comprising:
a processor; and
a memory in communication with the processor, the memory containing instructions that, when executed by the processor, cause the processor to:
receive a request to generate an automated compliance verification framework for an organization;
analyze, by a neural network, regulations of the organization;
analyze, by the neural network, existing record-keeping and data processing applications of the organization;
determine, by the neural network comparing data of the record-keeping and data processing applications against the regulations, a set of benchmarks derived from existing variables from the record-keeping and data processing applications to objectively verify compliance or non-compliance with the regulations; and
verify whether the organization is objectively in compliance with the regulations by causing a compliance system to execute an automated test of each of the set of benchmarks.

11. The system of claim 10, the memory containing additional instructions that, when executed by the processor, cause the processor to:
set a time to expire at predetermined intervals after determining the set of benchmarks;
identify that timer has expired after the predetermined interval; and
evaluate, by the neural network and in response to the instance of the periodic interval expiring, whether any of the regulations or record-keeping and data processing applications have changed such that it is no longer possible to verify that the organization is objectively in compliance with the regulations by causing the compliance system to execute the automated test of each of the set of benchmarks.

12. The system of claim 11, the memory containing additional instructions that, when executed by the processor, cause the processor to:
determine, by the neural network and in response to evaluating that the regulations have changed such that it is no longer possible to verify that the organization is objectively in compliance with the changed regulations, an updated set of benchmarks derived from the existing variables from the record-keeping and data processing applications to objectively verify compliance or non-compliance with the changed regulations; and
verify whether the organization is objectively in compliance with the changed regulations by causing a compliance system to execute a new version of the automated test of each of the updated set of benchmarks.

13. The system of claim 12, the memory containing additional instructions that, when executed by the processor, cause the processor to:
determine, by the neural network and in response to evaluating that the record-keeping and data processing applications have changed such that it is no longer possible to verify that the organization is objectively in compliance with the regulations, an updated set of benchmarks derived from new existing variables from the record-keeping and data processing applications to objectively verify compliance or non-compliance with the regulations; and
verify whether the organization is objectively in compliance with the regulations by causing a compliance system to execute a new version of the automated test of each of the updated set of benchmarks.

14. The system of claim 11, the memory containing additional instructions that, when executed by the processor, cause the processor to:
identify, by the neural network comparing data of the existing record-keeping and data processing applications against the regulations, one regulation of the regulations that is incapable of being objectively measured for compliance or non-compliance with the existing record-keeping and data processing applications; and
suggest, by the neural network, an alternative configuration of the existing record-keeping and data processing applications that would enable the one regulation to be objectively measured for compliance or non-compliance.

15. A computer program product, the computer program product comprising a computer readable storage medium having program instructions embodied therewith, the program instructions executable by a computer to cause the computer to:
receive a request to generate an automated compliance verification framework for an organization;
analyze, by a neural network, regulations of the organization;
analyze, by the neural network, existing record-keeping and data processing applications of the organization;
determine, by the neural network comparing data of the record-keeping and data processing applications against the regulations, a set of benchmarks derived from existing variables from the record-keeping and data processing applications to objectively verify compliance or non-compliance with the regulations; and
verify whether the organization is objectively in compliance with the regulations by causing a compliance system to execute an automated test of each of the set of benchmarks.

16. The computer program product of claim 15, the computer readable storage medium having additional program instructions embodied therewith, the program instructions executable by the computer to further cause the computer to:
set a time to expire at predetermined intervals after determining the set of benchmarks;
identify that timer has expired after the predetermined interval; and
evaluate, by the neural network and in response to the instance of the periodic interval expiring, whether any of the regulations or record-keeping and data processing applications have changed such that it is no longer possible to verify that the organization is objectively in compliance with the regulations by causing the compliance system to execute the automated test of each of the set of benchmarks.

17. The computer program product of claim 15, the computer readable storage medium having additional program instructions embodied therewith, the program instructions executable by the computer to further cause the computer to:
determine, by the neural network and in response to evaluating that the regulations have changed such that it is no longer possible to verify that the organization is objectively in compliance with the changed regulations, an updated set of benchmarks derived from the existing variables from the record-keeping and data processing applications to objectively verify compliance or non-compliance with the changed regulations; and
verify whether the organization is objectively in compliance with the changed regulations by causing a compliance system to execute a new version of the automated test of each of the updated set of benchmarks.

18. The computer program product of claim 17, the computer readable storage medium having additional program instructions embodied therewith, the program instructions executable by the computer to further cause the computer to:
determine, by the neural network and in response to evaluating that the record-keeping and data processing applications have changed such that it is no longer possible to verify that the organization is objectively in compliance with the regulations, an updated set of benchmarks derived from new existing variables from the record-keeping and data processing applications to objectively verify compliance or non-compliance with the regulations; and
verify whether the organization is objectively in compliance with the regulations by causing a compliance system to execute a new version of the automated test of each of the updated set of benchmarks.

19. The computer program product of claim 15, the computer readable storage medium having additional program instructions embodied therewith, the program instructions executable by the computer to further cause the computer to:
identify, by the neural network comparing data of the existing record-keeping and data processing applications against the regulations, one regulation of the regulations that is incapable of being objectively measured for compliance or non-compliance with the existing record-keeping and data processing applications; and
suggest, by the neural network, an alternative configuration of the existing record-keeping and data processing applications that would enable the one regulation to be objectively measured for compliance or non-compliance.

20. The computer program product of claim 15, the computer readable storage medium having additional program instructions embodied therewith, the program instructions executable by the computer to further cause the computer to generate a report regarding the results of the automated test, wherein the report includes specific data from each benchmark that enabled the compliance system to determine whether the organization is in compliance with each industry and internal regulation.
